(19) United States
(12) Patent Application Publication
(10) Pub. No.: US 2021/0406939 A1
(43) Pub. Date: Dec. 30, 2021

(54) A SYSTEM AND METHOD FOR QUALITY-DRIVEN INCENTIVES FOR CONTINUOUS DATA MAINTENANCE AND FAIR VALUE-EXCHANGE IN BUSINESS ECO-SYSTEMS

(71) Applicant: International Business Machines Corporation, Armonk, NY (US)

(72) Inventors: Dany Moshkovich, Yokneam Ilit (IL); NATHAN M. HAZOUT, Netanya (IL); Jonathan Bnayahu, Haifa (IL); Brian GAMAGE, Canton, GA (US); Marie Elizabeth Wallace, Dublin (IE)

(21) Appl. No.: 16/911,431

(22) Filed: Jun. 25, 2020

(51) Int. Cl. G06Q 30/02; G06F 16/11

(52) U.S. Cl. CPC G06Q 30/0208; G06F 16/122

(57) ABSTRACT

Embodiments of the present systems and methods may provide quality-driven incentives for continuous data maintenance and fair value-exchange in business eco-systems that may ensure high quality data over time. For example, a method of data management processing may be implemented in a computer system and the method may comprise determining a quality of data submitted by a data provider over a plurality of quality dimensions, curating the submitted data over multiple data providers based on the plurality of quality dimensions, and rewarding the data provider based on the determined quality of the data submitted by the data provider, an expected lifetime of the data, and the data consumers that access the data so as to incentivize the data provider to provide the data and to maintain or improve the quality of the data.

### BACKGROUND

The present invention relates to techniques that provide quality-driven incentives for continuous data maintenance and fair value-exchange in business eco-systems.

High quality data is crucial for the successful operation of many systems and in some domains even governed by policies and regulations. Low quality data may result in high downstream operational costs, fines, and may even compromise the reputation of an organization. The collection of data can be an expensive process that may even involve manual work, and is sometimes done by different organizations separately, duplicating the overall efforts and causing possible disputes. As data changes over time, continuous investment is needed to maintain its quality, and these investments are redundant and wasteful from an industry perspective. Moreover, data providers need to share the same data multiple times, across different channels and different formats, leading to higher operational costs and reluctance to make the updates. In order to establish an eco-system that can continuously maintain high quality data, there is a need to define financial incentives and the mechanisms to keep them fair. Current approaches are either based on crowd sourcing, thereby compromising quality, or are putting all the responsibility to curate the data with a single party, thereby creating possible vendor lock-in.

Accordingly, a need arises for techniques that provide quality-driven incentives for continuous data maintenance and fair value-exchange in business eco-systems.

### SUMMARY

Embodiments of the present systems and methods may provide quality-driven incentives for continuous data maintenance and fair value-exchange in business eco-systems that may ensure high quality data over time. Embodiments may enable data consumers to manage and limit their budgets, give rewards only for the data they consume, factor rewards based on data quality over time, and share the cost with all other consumers of the same data. Embodiments may also reward data providers for quality-increasing actions over time, and may motivate sharing the data with multiple consumers. Embodiments may provide fair opportunities for all eligible data providers in a competitive environment. Embodiments may enable multiple data providers to create, update, validate and report issues on the data as a revenue stream that leverages their existing knowledge and expertise in the domain. Embodiments may evaluate the provided data to estimate its quality metrics across multiple dimensions, curates it and determines how providers should be rewarded for their contribution. Embodiments may track the quality of provided data over time and may adjust the confidence in the source of the data as a result of detected or reported issues to avoid inappropriate behavior. Accordingly, embodiments may provide the capability to reflect the data quality and time dimensions to ensure fair value exchange in the eco-system.

Embodiments may enable fair value exchange between data providers and consumers. Embodiments may drive higher quality of data and increase the data update/validation rate. For example, data consumers may have objectives such as to manage and constrain the provider rewards budget, reward providers only for data consumed, reward providers according to quality measures over time, and share the cost amongst all data consumers. Likewise, data providers may have objectives such as to be rewarded for data quality-increasing actions, be rewarded for the long term quality of data, have equal opportunities for all eligible data providers, and be rewarded for contribution to multiple data consumers.

In an embodiment, a method of data management processing may be implemented in a computer system comprising a processor, memory accessible by the processor, and computer program instructions stored in the memory and executable by the processor, the method may comprise determining a quality of data submitted by a data provider over a plurality of quality dimensions, curating the submitted data over multiple data providers based on the plurality of quality dimensions, and rewarding the data provider based on the determined quality of the data submitted by the data provider, an expected lifetime of the data, and the data consumers that access the data so as to incentivize the data provider to provide the data and to maintain or improve the quality of the data.

In embodiments, the reward to the data provider may be based on a quality of the data over time, subject to a maximum reward per unit time, and is reduced based on a decreased quality of the data, wherein the quality of the data decreases over time unless maintained. The data provider or another party may be rewarded for maintaining the quality of the data. The data consumers may share providing the rewards to the data provider and to another party based on a number of the data consumers and an amount of time each data consumer uses the data. The data provider may receive a bonus reward based on multiple data consumers using the data. Determining a quality of data submitted by a data provider may be based on at least one quality dimension selected from a group consisting of validity, completeness, consistency, accuracy, freshness, and confidence of the submitted data according to policies defined for each data type.

In an embodiment, a system for data management processing may comprise a processor, memory accessible by the processor, and computer program instructions stored in the memory and executable by the processor to perform determining a quality of data submitted by a data provider over a plurality of quality dimensions, curating the submitted data over multiple data providers based on the plurality of quality dimensions, and rewarding the data provider based on the determined quality of the data submitted by the data provider, an expected lifetime of the data, and the data consumers that access the data so as to incentivize the data provider to provide the data and to maintain or improve the quality of the data.

In an embodiment, a computer program product for visual recognition processing may comprise a non-transitory computer readable storage having program instructions embodied therewith, the program instructions executable by a computer, to cause the computer to perform a method comprising determining a quality of data submitted by a data provider over a plurality of quality dimensions, curating the submitted data over multiple data providers based on the plurality of quality dimensions, and rewarding the data provider based on the determined quality of the data submitted by the data provider, an expected lifetime of the data, and the data consumers that access the data so as to incentivize the data provider to provide the data and to maintain or improve the quality of the data.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary diagram of a system according to embodiments of the present techniques.

FIG. 2 is an exemplary illustration of quality dimensions according to embodiments of the present techniques.

FIG. 3 is an exemplary illustration of a quality calculation according to embodiments of the present techniques.

FIG. 4 is an exemplary illustration of changes in record quality over time according to embodiments of the present techniques.

FIG. 5 is an exemplary illustration of changes in record quality over time according to embodiments of the present techniques.

FIG. 6 is an exemplary illustration of data provision and data quality maintenance incentivization according to embodiments of the present techniques.

FIG. 7 is an exemplary block diagram of a computer system, in which processes involved in the embodiments described herein may be implemented.

### DETAILED DESCRIPTION

Embodiments of the present systems and methods may provide quality-driven incentives for continuous data maintenance and fair value-exchange in business eco-systems that may ensure high quality data over time. Embodiments may enable data consumers to manage and limit their budgets, give rewards only for the data they consume, factor rewards based on data quality over time, and share the cost with all other consumers of the same data. Embodiments may also reward data providers for quality-increasing actions over time, and may motivate sharing the data with multiple consumers. Embodiments may provide fair opportunities for all eligible data providers in a competitive environment. Embodiments may enable multiple data providers to create, update, validate and report issues on the data as a revenue stream that leverages their existing knowledge and expertise in the domain. Embodiments may evaluate the provided data to estimate its quality metrics across multiple dimensions, curates it and determines how providers should be rewarded for their contribution. Embodiments may track the quality of provided data over time and may adjust the confidence in the source of the data as a result of detected or reported issues to avoid inappropriate behavior. Accordingly, embodiments may provide the capability to reflect the data quality and time dimensions to ensure fair value exchange in the eco-system.

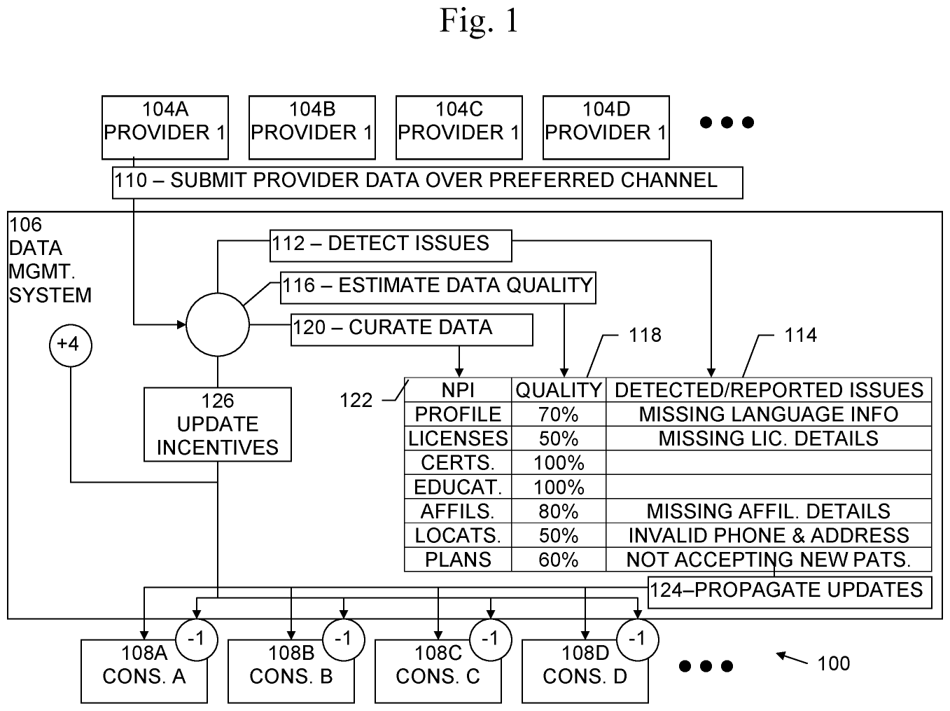

An exemplary system 100 utilizing the present techniques is shown in FIG. 1. As shown in FIG. 1, system 100 may include a plurality of data providers 104A-D, etc., data management system 106, and a plurality of data consumers 108A-D, etc. Data providers 104A-D, etc. may include any system or type of system that may provide data to data management system 106, regardless of how the data is obtained, gathered, generated, etc. Data consumers 108A-D, etc. may include any system or type of system that may consume data from data management system 106, regardless of how the data is obtained, gathered, generated, etc. System enables data providers 104A-D, etc. to contribute their input to the system and be rewarded if their input improved the overall quality of the data.

Also shown in FIG. 1 is an example of a process of operational flow in system 100. The process begins with 110, in which data providers 104A-D, etc. may submit data over, for example, multiple channels to data management system 106. At 112, data management system 106 may analyze the submitted data to detect issues 114 with the submitted data. Examples of such issues 114 may include missing language information, missing license details, missing affiliation details, invalid phone number and/or address, non-acceptance of new patients or customers, etc. At 116, data management system 106 may generate an estimate of the quality 118 of the submitted data, for example, in the form of a percentage of quality. Data with no issues 114 may be assigned 100% quality, while data with issues 114 may be assigned a lower quality measure.

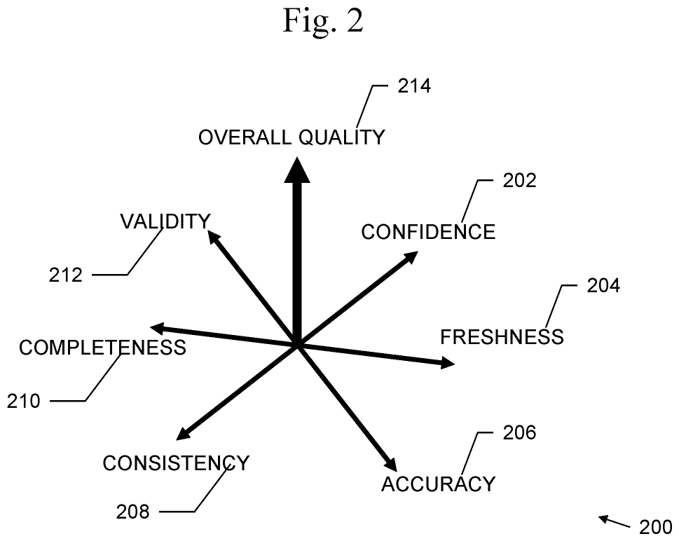

For example, data management system 106 may assess the provided data for a plurality of quality factors or quality dimensions 200, an example of which is shown in FIG. 2. For example, quality dimensions may include confidence 202, freshness 204, accuracy 206, consistency 208, completeness 210, and validity 212, according to the policies defined for each data type. Confidence 202 may relate to the reliability of the data source for a data type, derived from past performance. Freshness 204 may relate to the measure of the recency of the data as a function of its expected lifetime. Accuracy 206 may relate to the degree to which the data matches reality, as reported by data consumers. Consistency 208 may relate to the measure of quality and alignment of related data elements. Completeness 210 may relate to the degree to which the collected data meets the requirements of expected use case. Validity 212 may relate to conformance of data to the syntax {format, type, range) of its definition. An overall quality dimension 214 may be calculated based on the other quality dimensions.

Issues detected by the system may compromise the data consistency, while issues reported by data providers may reduce data accuracy. Embodiments may analyze the quality of data provided by each data provider over time, and accordingly detect or report issues that may compromise confidence in future operations of that data provider.

At 120, data management system 106 may curate the data and generate or compute Record Quality metrics for a plurality of records based on a plurality of parameters 122. Record updates that have been accepted based on their quality may be propagated 124 to data consumers 108A-D, etc. Further, incentives for data providers 104A-D, etc. may be updated 126 to reflect the quantity and quality of data received from those providers.

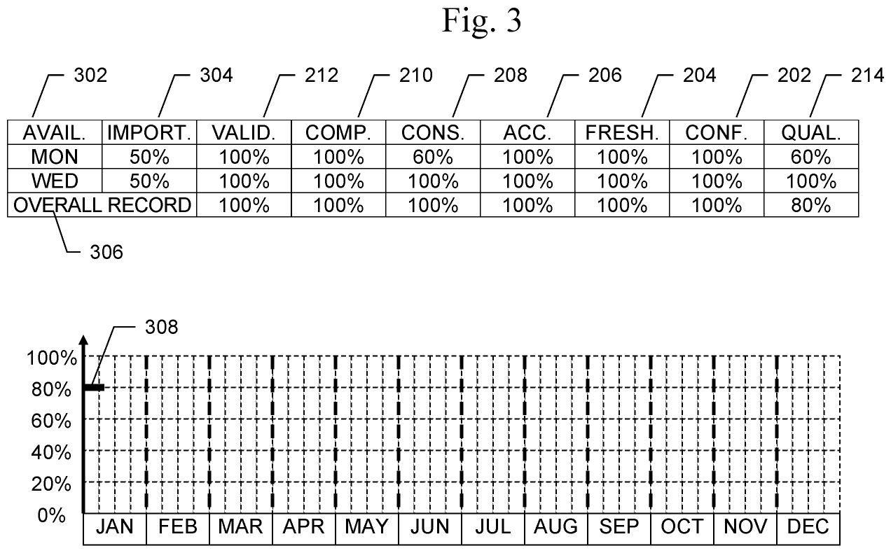

An example of a quality calculation is shown in FIG. 3. For example, on creation of a data record, system 106 may determine a quality of the created record. In this example, the quality dimensions confidence 202 (F_{confidence}), freshness 204 (F_{importance}), accuracy 206 (F_{accuracy}), consistency 208 (F_{consistency}), completeness 210 (F_{completeness}), and validity 212 (F_{validity}) may be assigned values and may be evaluated based on periods of availability 302 and on the importance 304 of the data. For example, the data may be available Monday, 9 am to 5 μm and also Wednesday, 9 am to 5 pm. Likewise, an importance 304 (F_{importance}) of the data may be assigned or determined, and may be defined by system policies for each field. Further, an overall quality record 306 over a plurality of periods of availability may be determined, and may be plotted 308. Embodiments may determine data quality for entire datasets or portions of datasets, down to individual records. The overall quality 214 may be derived as a product over multiple quality dimensions 202-212. For example, the record quality (RQ) may be determined according to:

RQ=Σ_{F}^{Fields}F_{importance}*F_{completeness}*F_{consistency}*F_{accuracy}*F_{freshness}*F_{confidence}

Data management system 106 may curate the data from multiple data providers and accept only those operations that improve the overall data quality.

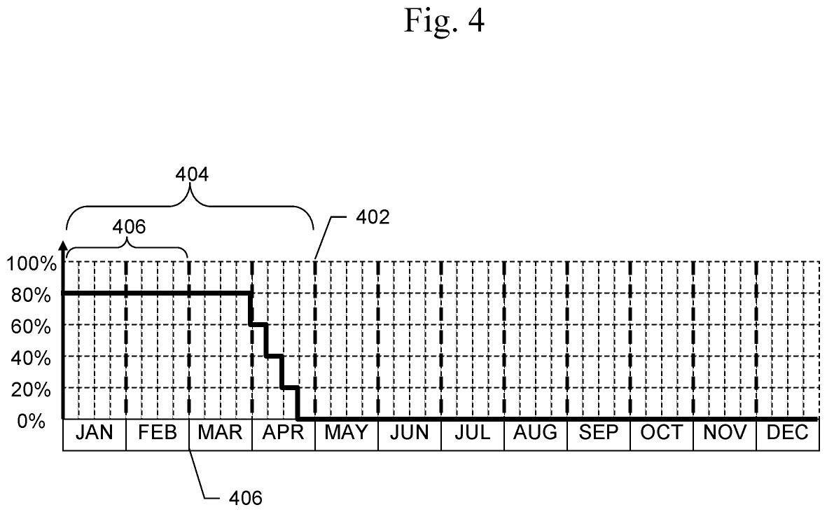

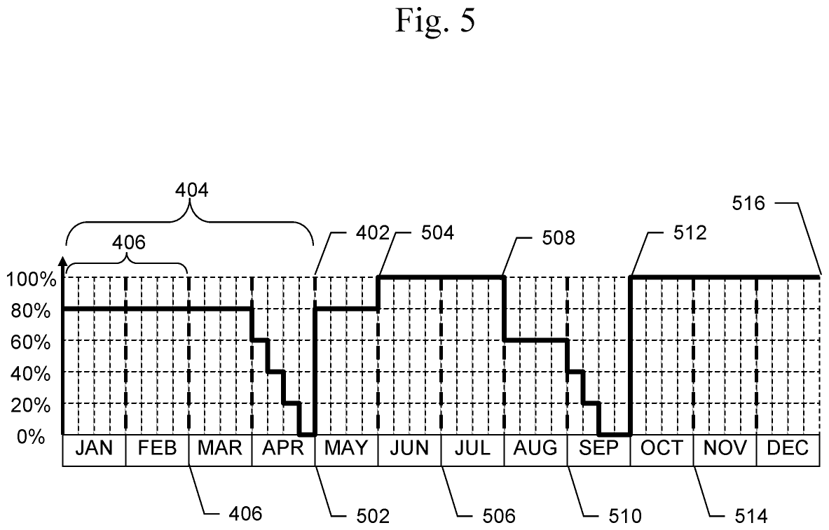

While some dimensions of data quality may not change with time, data freshness 204 may degrade over time to reflect its expected lifetime. For example, FIGS. 4 and 5 illustrate changes in record quality over time. As shown in FIG. 4, an unvalidated record may go stale 402 after the Obsolescent Time Interval (OTI) 404 at the Obsolescent Rate (OR), for example, 20% per week. Time intervals may be short (months) for frequently changing records like availability and long (years) for stable records like licenses. The intervals may be adjusted based on the analysis of records updates over time. The record may be expected to be validated after Validation Time Interval (VTI) 406.

Each accepted operation may reward the data provider according to the overall quality score, expected lifetime of the data, and the number of data consumers who access the data during its lifetime. These rewards may be covered by consumers of the data according to the time interval they are using it.

For example, rewards may be calculated as described below, where RB is the Rewards Budget in points, which limits data consumer costs for maintaining a single data entry at overall quality of 100%, and RQ(t) is the Record Quality as derived from multiple dimensions at time t. For example Q(t) represents a case where unvalidated data goes stale after Obsolescent Time Interval (OTI) at the Obsolescent Rate (OR). NCR(t) is the number of Consumers for the Record at time t. OSB is the Out of Savings Bonus, which may determine the percentage added to data providers out of saving on sharing costs between multiple data consumers as a benefits for providing value to multiple data consumers

An example of a quality calculation is shown in FIG. 5. For example, on creation of a data record, system 106 may determine a quality of the created record. The record may be expected to be validated after Validation Time Interval (VTI) 406. An unvalidated record may go stale 402 after Obsolescent Time Interval (OTI) 404 at the Obsolescent Rate (OR), for example, 20% per week. As shown in this example, record validation 502 may cause an update to the record quality. Data updates at higher quality may be accepted and the quality may be updated 504. Data updates of lower quality may be rejected 506. A reported issue may cause a reduction in record quality 508. An unvalidated record may start to become stale 510 after the Obsolescent Time Interval (OTI) 404 at the Obsolescent Rate (OR). A resolved issue may cause a restart of the validation interval 512. A record validation before the Validation Time Interval (VTI) may be rejected 514, while a record validation after the Validation Time Interval (VTI) may restart the validation interval.

The Record Quality may be computed as a function of time according to, for example:

$$RQ ( t ) = \{ \begin{matrix}RQ ( 0 ) , & t < OTI \\ R Q ( t ) = R Q ( 0 ) - OR * ( t - OTI ) , & OTI \leq t < OTI + \frac{R Q ( 0 )}{OR} \\ 0 , & t \geq OTI + \frac{R Q ( 0 )}{OR}\end{matrix}$$

where RQ(t) is an overall quality of a record of data at a time t, OTI is an Obsolescent Time Interval, and OR is an Obsolescent Rate.

ECO(T₀) may represent an Expected Cost of Operation for a Data consumer 108A-D, etc. at time of operation T₀. For example, the Expected Cost of Operation may be computed according to:

$$E C O ( {T}_{0} ) = \frac{R B}{N C R ( {T}_{0} )} ( 1 - 0 S B ( N C R ( {T}_{0} ) - 1 ) {\int }_{{T}_{0}}^{∞} R Q ( t ) d t$$

where RB is a Rewards Budget in points to limit data consumer costs for maintaining the record at an overall quality of 100%, and OSB is an Out of Savings Bonus that determines a percentage added to data providers based on saving on sharing costs between multiple data consumers as a benefits for providing value to multiple data consumers.

EOR(t) may represent an Expected Operation Reward received by the data providers at the time of operation. For example, the Expected Operation Reward may be computed according to:

EOR(t)=NCR(t)*ECO(t)

Data management system 106 may track all the activities on the network and update 126 the rewards balance according to the changes in record quality source of the data and the amount of data consumers during the lifetime of the entry to represent the actual state of the system.

Embodiments may enable fair value exchange between data providers and consumers. Embodiments may drive higher quality of data and increase the data update/validation rate. For example, data consumers may have objectives such as to manage and constrain the provider rewards budget, reward providers only for data consumed, reward providers according to quality measures over time, and share the cost amongst all data consumers. Likewise, data providers may have objectives such as to be rewarded for data quality-increasing actions, be rewarded for the long term quality of data, have equal opportunities for all eligible data providers, and be rewarded for contribution to multiple data consumers.

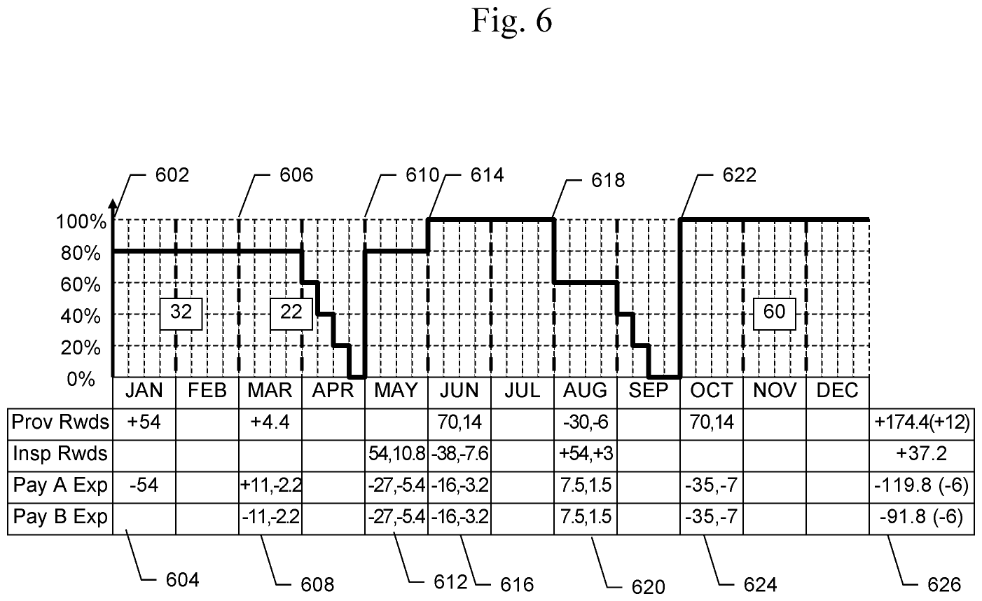

An example of data provision and data quality maintenance incentivization is shown in FIG. 6. For example, a provider may create 602 a data record, which may be given a quality metric, in this example, 80%. The provider may be rewarded for providing the data based on the quality of the data and the time the data has that quality. For example, the provider may be rewarded with 5 points per week for 100% quality. In the example shown in FIG. 6, in the absence of any other events, at 604, the provider would be rewarded 54 points for the period January through April (32 points for January and February, and 22 points for March and April, due to decreasing quality metric of the data record in April), while the data consumer/payer A would pay 54 points. If, at the beginning of March, another data consumer/payer B is enrolled in the system 606, then, for March and April, then data consumer/payer B would cover half of the rewards paid by data consumer/payer A. Thus, at 608, data consumer/payer B would pay 11 points to data consumer/payer A. In addition, a bonus percentage may be applied based on the cost savings to each data consumer/payer due to sharing the data record. For example, with a 20% bonus, the data provider would be rewarded with 4.4 points, and each of data consumer/payer A and data consumer/payer B would pay an additional 2.2 points.

At 610, a data inspector may validate the data record, returning the data record quality metric to 80% and the data inspector may themselves be rewarded. Assuming no further events, in this example, at 612, the data inspector would be rewarded 54 points for the data from May to August, and 10.8 points for a 20% bonus. Further, at 612, each of data consumer/payer A and data consumer/payer B would pay an 27 points plus an additional 5.4 points bonus. However, in this example, at 614, at the beginning of June, the data provider updates the data record, raising the data record quality metric to 100%. Accordingly, at 616, the data provider is rewarded with 70 points for June through September, plus a 20% bonus of 14 points. The data inspector then must return their rewards for June through August, 38 points plus 7.6 points bonus, and the data consumers/payers each pay half the remainder paid to the data provider, 16 points plus 3.2 points bonus.

At 618, the data inspector reports an issue with the data record, which decreases the data quality metric for the data record for August and September. At 620, the data inspector is rewarded for reporting the issue, in this example, with 15 points plus 3 points bonus, the data provider must refund some of their reward due to the decrease in data record quality, in this example, 30 points plus 6 points bonus, and the data consumers/payers are each refunded due to the decrease in the quality of the data they consumed, in this example, 7.5 points plus 1.5 points bonus. At 622, the data provider resolves the issue and is rewarded 624 for 100% quality data for October through December with 70 points plus 14 points bonus, and the data consumers/payers each pay half the reward paid to the data provider, 35 points plus 7 points bonus.

This example concludes with the data provider having a yearly balance of 174.4 points, plus 12 points the next year for the remaining value of the data record, the data inspector having a having a yearly balance of 37.2 points, and data consumer/payer A having a yearly balance of −119.8 points, plus −6 points the next year for the remaining value of the data record, and data consumer/payer B having a yearly balance of −91.8 points, plus −6 points the next year for the remaining value of the data record.

The example shown in FIG. 6 illustrates how rewards may be calculated according to the expected lifetime, quality of provided data and some percentage out of cost sharing savings of data consumers. For example, the data consumer/payer expenses may be computed as:

$$\frac{Max points per week}{Number of data consumers} \cdot ( 1 + bonus percent \cdot ( Number of data consumers - 1 ) ) \cdot \\ {{\sum }^{Lifetime}}_{k = 1} ( Expected quality of data at week k ) .$$

Likewise, the data provider reward may be computed as:

Number of data consumers*Data consumer expenses.

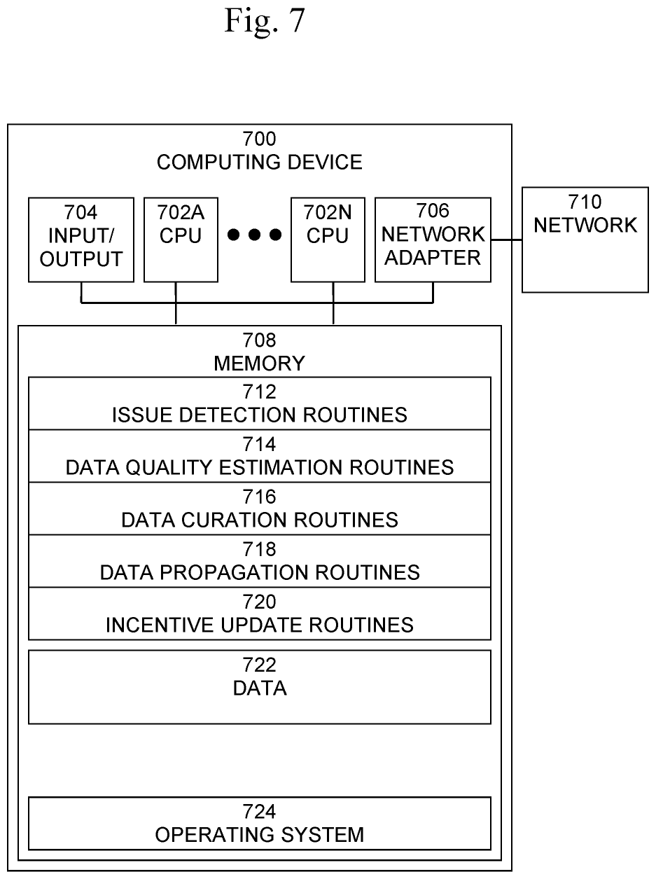

An exemplary block diagram of a computer system 700, in which processes involved in the embodiments described herein may be implemented, is shown in FIG. 7. Computer system 700 may be implemented using one or more programmed general-purpose computer systems, such as embedded processors, systems on a chip, personal computers, workstations, server systems, and minicomputers or mainframe computers, or in distributed, networked computing environments. Computer system 700 may include one or more processors (CPUs) 702A-402N, input/output circuitry 704, network adapter 706, and memory 708. CPUs 702A-402N execute program instructions in order to carry out the functions of the present communications systems and methods. Typically, CPUs 702A-402N are one or more microprocessors, such as an INTEL CORE® processor. FIG. 7 illustrates an embodiment in which computer system 700 is implemented as a single multi-processor computer system, in which multiple processors 702A-402N share system resources, such as memory 708, input/output circuitry 704, and network adapter 706. However, the present communications systems and methods also include embodiments in which computer system 700 is implemented as a plurality of networked computer systems, which may be single-processor computer systems, multi-processor computer systems, or a mix thereof.

Input/output circuitry 704 provides the capability to input data to, or output data from, computer system 700. For example, input/output circuitry may include input devices, such as keyboards, mice, touchpads, trackballs, scanners, analog to digital converters, etc., output devices, such as video adapters, monitors, printers, etc., and input/output devices, such as, modems, etc. Network adapter 706 interfaces device 700 with a network 710. Network 710 may be any public or proprietary LAN or WAN, including, but not limited to the Internet.

Memory 708 stores program instructions that are executed by, and data that are used and processed by, CPU 702 to perform the functions of computer system 700. Memory 708 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 708 may vary depending upon the function that computer system 700 is programmed to perform. In the example shown in FIG. 7, exemplary memory contents are shown representing routines and data for embodiments of the processes described above. However, one of skill in the art would recognize that these routines, along with the memory contents related to those routines, may not be included on one system or device, but rather may be distributed among a plurality of systems or devices, based on well-known engineering considerations. The present systems and methods may include any and all such arrangements.

In the example shown in FIG. 7, memory 708 may include issue detection routines 712, data quality estimation routines 714, data curation routines 716, data propagation routines 718, incentive update routines 720, and data 722, and operating system 724. Issue detection routines 712 may include software routines to analyze the submitted data to detect issues with the submitted data, as described above. Data quality estimation routines 714 may include software routines to generate an estimate of the quality of the submitted data, as described above. Data curation routines 716 may include software routines to curate the data and generate or compute record quality metrics for a plurality of records based on a plurality of parameters, as described above. Data propagation routines 718 may include software routines to propagate record updates that have been accepted based on their quality to data consumers, as described above. Incentive update routines 720 may include software routines to update the rewards balance according to the changes in record quality source of the data and the amount of data consumers, as described above. Data 722 may include submitted data, curated data, etc., as described above. Video stream data 724 may include a stream or series of still images, as described above. Operating system 726 may provide overall system functionality.

As shown in FIG. 7, the present communications systems and methods may include implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A method of data management processing, implemented in a computer system comprising a processor, memory accessible by the processor, and computer program instructions stored in the memory and executable by the processor, the method comprising:
computing a measure of a quality of data submitted by a data provider over a plurality of quality dimensions including:
validity by determining conformance of the submitted data to a syntax of a definition of the submitted data,
completeness by determining a degree to which the submitted data meets requirements of use of the submitted data,
consistency by determining a measure of quality and alignment of related elements of the submitted data,
accuracy by determining a degree to which the submitted data matches reality,
freshness by determining a measure of recency of the submitted data as a function of an expected lifetime of the submitted data, and
confidence by determining a reliability of the submitted data source for a data type, derived from past performance of data source of the submitted data, according to policies defined for each data type;
computing metrics for the submitted data over multiple data providers based on the plurality of quality dimensions; and
computing a reward to the data provider based on the computing metrics of the data submitted by the data provider, the expected lifetime of the data, and the data consumers that access the data so as to incentivize the data provider to provide the data and to maintain or improve the quality of the data.

2. The method of claim 1, wherein the reward to the data provider is based on a quality of the data over time, subject to a maximum reward per unit time, and is reduced based on a decreased quality of the data, wherein the quality of the data decreases over time unless maintained and the expected lifetime of the data may comprise an obsolescent time interval or a validation time interval and wherein the quality of the data may decrease at an obsolescence rate.

3. The method of claim 2, wherein the data provider or another party is rewarded for maintaining the quality of the data.

4. The method of claim 3, wherein the data consumers share providing the rewards to the data provider and to another party based on a number of the data consumers and an amount of time each data consumer uses the data.

5. The method of claim 4, wherein the data provider receives a bonus reward based on multiple data consumers using the data.

6. (canceled)

7. A system for data management processing, the system comprising a processor, memory accessible by the processor, and computer program instructions stored in the memory and executable by the processor to perform:
computing a measure of a quality of data submitted by a data provider over a plurality of quality dimensions including:
validity by determining conformance of the submitted data to a syntax of a definition of the submitted data,
completeness by determining a degree to which the submitted data meets requirements of use of the submitted data,
consistency by determining a measure of quality and alignment of related elements of the submitted data,
accuracy by determining a degree to which the submitted data matches reality,
freshness by determining a measure of recency of the submitted data as a function of an expected lifetime of the submitted data, and
confidence by determining a reliability of the submitted data source for a data type, derived from past performance of data source of the submitted data, according to policies defined for each data type;
computing metrics for the submitted data over multiple data providers based on the plurality of quality dimensions; and
computing a reward to the data provider based on the computing metrics of the data submitted by the data provider, the expected lifetime of the data, and the data consumers that access the data so as to incentivize the data provider to provide the data and to maintain or improve the quality of the data.

8. The system of claim 7, wherein the reward to the data provider is based on a quality of the data over time, subject to a maximum reward per unit time, and is reduced based on a decreased quality of the data, wherein the quality of the data decreases over time unless maintained and the expected lifetime of the data may comprise an obsolescent time interval or a validation time interval and wherein the quality of the data may decrease at an obsolescence rate.

9. The system of claim 8, wherein the data provider or another party is rewarded for maintaining the quality of the data.

10. The system of claim 9, wherein the data consumers share providing the rewards to the data provider and to another party based on a number of the data consumers and an amount of time each data consumer uses the data.

11. The system of claim 10, wherein the data provider receives a bonus reward based on multiple data consumers using the data.

12. (canceled)

13. A computer program product for visual recognition processing, the computer program product comprising a non-transitory computer readable storage having program instructions embodied therewith, the program instructions executable by a computer, to cause the computer to perform a method comprising:
computing a measure of a quality of data submitted by a data provider over a plurality of quality dimensions including:
validity by determining conformance of the submitted data to a syntax of a definition of the submitted data,
completeness by determining a degree to which the submitted data meets requirements of use of the submitted data,
consistency by determining a measure of quality and alignment of related elements of the submitted data,
accuracy by determining a degree to which the submitted data matches reality,
freshness by determining a measure of recency of the submitted data as a function of an expected lifetime of the submitted data, and
confidence by determining a reliability of the submitted data source for a data type, derived from past performance of data source of the submitted data, according to policies defined for each data type;
computing metrics for the submitted data over multiple data providers based on the plurality of quality dimensions; and
computing a reward to the data provider based on the computing metrics of the data submitted by the data provider, the expected lifetime of the data, and the data consumers that access the data so as to incentivize the data provider to provide the data and to maintain or improve the quality of the data.

14. The computer program product of claim 13, wherein the reward to the data provider is based on a quality of the data over time, subject to a maximum reward per unit time, and is reduced based on a decreased quality of the data, wherein the quality of the data decreases over time unless maintained and the expected lifetime of the data may comprise an obsolescent time interval or a validation time interval and wherein the quality of the data may decrease at an obsolescence rate.

15. The computer program product of claim 14, wherein the data provider or another party is rewarded for maintaining the quality of the data.

16. The computer program product of claim 15, wherein the data consumers share providing the rewards to the data provider and to another party based on a number of the data consumers and an amount of time each data consumer uses the data.

17. The computer program product of claim 16, wherein the data provider receives a bonus reward based on multiple data consumers using the data.

18. (canceled)
